(19) United States
(12) Patent Application Publication
(10) Pub. No.: US 2013/0065993 A1
(43) Pub. Date: Mar. 14, 2013

(54) Polymer Compositions Containing Alkoxysilanes

(71) Applicants: Michael Backer, Mainz (DE); Pierre Chevalier, Lille (FR); Zhihua Liu, Shanghai (CN); Ana Marques, Portela LRS (PT); Satoshi Onodera, Ichihara City (JP); Vincent Rerat, Tubize (BE); Motoshi Sasaki, Ichihara City (JP)

(72) Inventors: Michael Backer, Mainz (DE); Pierre Chevalier, Lille (FR); Zhihua Liu, Shanghai (CN); Ana Marques, Portela LRS (PT); Satoshi Onodera, Ichihara City (JP); Vincent Rerat, Tubize (BE); Motoshi Sasaki, Ichihara City (JP)

(73) Assignees: DOW CORNING CORPORATION, Midland, MI (US); DOW CORNING (SHANGHAI) CO., LTD., Shanghai, CN (CN); DOW CORNING TORAY CO., LTD., Tokyo, JP (JP)

(21) Appl. No.: 13/698,828

(22) PCT Filed: May 16, 2011
(86) PCT No.: PCT/CN11/00844

§ 371 Date: Nov. 19, 2012

(30) Foreign Application Priority Data
May 20, 2010 (CN) PCT/CN2010/000718
Jun. 1, 2010 (CN) PCT/CN2010/000777

(51) Int. Cl. C08K 5/544; C08K 3/36; C08L 69/00; C08L 83/08; C08K 5/5419

(52) U.S. Cl. 524/87; 525/477; 524/110; 525/461

(57) ABSTRACT

The invention provides a process for improving the fire resistance of a thermoplastic or thermoset organic polymer composition, characterised in that an alkoxysilane containing at least one organic nitrogen-containing group and an alkoxysilane or silicone resin containing at least one group selected from phosphonate and phosphinate groups are added to a thermoplastic or thermosetting organic polymer composition and heated in the presence of moisture to cause hydrolysis and siloxane condensation of the alkoxysilane or alkoxysilanes. The alkoxysilanes, or alkoxysilane(s) and silicone resin, of the invention are particularly effective in increasing the fire resistance of polycarbonates and blends of polycarbonate with other resins such as polycarbonate/ABS blends.

This invention relates to the use of alkoxysilanes to improve the fire resistance of organic polymer compositions. The invention includes a process for improving the fire resistance of a thermoplastic, thermoset or rubber organic polymer composition, and includes organic polymer compositions containing the alkoxysilanes.

US-A-2007/0167597 describes phosphone ester modified organosilicon compounds prepared by reacting phosphonic ester functionalized alkoxysilane with a silanol-functional organosilicon compound.

CN-A-101274998 describes an epoxy phosphorus-containing hybridization hardener with heat resistance and flame retardancy for electron polymer material and a preparation method thereof. The phosphorus-containing hybridization hardener is a nanometer-sized organic/inorganic hybrid silicone of a hollow enclosed type or a partially enclosed type, wherein the structure centre of the silicone consists of inorganic skeleton Si—O bonds. The external structure consists of organic groups of organic phosphor or amidogen or imidogen.

The paper ‘Thermal degradation behaviours and flame retardancy of PC/ABS with novel silicon-containing flame retardant’ by Hanfang Zhong et al. in Fire. Mater. Vol. 31, 411-423 (2007) describes a novel flame retardant containing silicon, phosphorus and nitrogen synthesised from the reaction of 9,10-dihydro-oxa-10-phosphaphenanthrene-10-oxide (DOPO), vinylmethyldimethoxysilane and N-β-(aminoethyl)-γ-aminopropyl methyl dimethoxy silane.

The paper ‘Siloxane-phosphonate finishes on cellulose: thermal characterization and flammability data’ presented by S. Gallagher et al at 2004 Beltwide Cotton Conferences describes applying siloxane phosphonate monomers to cotton fabric.

The paper ‘New flame retarded polyamide-6 elaborated by in situ generation of phosphorylated silica through extrusion process’ by P. Van Nieuwenhuyse et al. in Modest 2008 describes flame retarded polyamide-6 containing phosphorylated silica formed in situ by incorporating diethylphosphatoethyltriethoxysilane in molten polyamide-6 during an extrusion process.

The paper ‘Synthesis of benzoxazine functional silane and adhesion properties of glass fibre reinforced polybenzoxazine composites’ by H. Ishida et al in J. Applied Polymer Science (1998), 69, 2559-2567 describes the synthesis of a benzoxazine functional alkoxysilane and its use to treat glass fibres which are then incorporated in glass fibre reinforced polybenzoxazine composites.

Due to the widespread and increasing use of synthetic polymers and natural or synthetic rubber, there are a large number of flame retardant compounds in use in today's plastic and rubber markets. Halogen containing flame retardants have performed well in terms of flame retardancy properties, processability, cost, etc, however there is an urgent need for halogen-free flame retardants (HFFR) as polymer additives, which comply with environmental regulations, OEM perception, customers requirements, etc. Fire safety is now based on preventing ignition and reducing flame spread through reducing the rate of heat release, as well as on reducing fire toxicity. Flame retardant additives must be safe in what concerns health and environment, must be cost efficient and maintain/improve plastics or rubbers performance.

The halogenated flame retardant compounds act mostly in the vapour phase by a radical mechanism to interrupt the exothermic processes and to suppress combustion. Examples are the bromine compounds, such as tetrabromobisphenol A, chlorine compounds, halogenated phosphate ester, etc.

Among the halogen-free flame retardants one can find the metal hydroxides, such as magnesium hydroxide (Mg(OH)₂) or aluminium hydroxide (Al(OH)₃), which act by heat absorbance, i.e. endothermic decomposition into the respective oxides and water when heated, however they present low flame retardancy efficiency, low thermal stability and significant deterioration of the physical/chemical properties of the matrices. Other compounds act mostly on the condensed phase, such as expandable graphite, organic phosphorous (e.g. phosphate, phosphonates, phosphine, phosphine oxide, phosphonium compounds, phosphites, etc.), ammonium polyphosphate, etc. Zinc borate, nanoclays and red phosphorous are other examples of halogen-free flame retardants. Silicon-containing additives are known to significantly improve the flame retardancy, acting both through char formation in the condensed phase and by the trapping of active radicals in the vapour phase. Sulfur-containing additives, such as potassium diphenylsulfone sulfonate (KSS), are well known flame retardant additives for thermoplastics, in particular for polycarbonate.

Either the halogenated, or the halogen-free compounds can act by themselves, or as synergetic agent together with the compositions claimed in the present patent to render the desired flame retardance performance to many polymer or rubber matrices. For instance, phosphonate, phosphine or phosphine oxide have been referred in the literature as being anti-dripping agents and can be used in synergy with the flame retardant additives disclosed in the present patent. The paper “Flame-retardant and anti-dripping effects of a novel char-forming flame retardant for the treatment of poly(ethylene terephthalate) fabrics” presented by Dai Qi Chen et al. at 2005 Polymer Degradation and Stability describes the application of a phosphonate, namely poly(2-hydroxy propylene spirocyclic pentaerythritol bisphosphonate) to impart flame retardance and dripping resistance to poly(ethylene terephthalate) (PET) fabrics. Benzoguanamine has been applied to PET fabrics to reach anti-dripping performance as reported by Hong-yan Tang et al. at 2010 in “A novel process for preparing anti-dripping polyethylene terephthalate fibres”, Materials & Design. The paper “Novel Flame-Retardant and Anti-dripping Branched Polyesters Prepared via Phosphorus-Containing Ionic Monomer as End-Capping Agent” by Jun-Sheng Wang et al. at 2010 reports on a series of novel branched polyester-based ionomers which were synthesized with trihydroxy ethyl esters of trimethyl-1,3,5-benzentricarboxylate (as branching agent) and sodium salt of 2-hydroxyethyl 3-(phenylphosphinyl)propionate (as end-capping agent) by melt polycondensation. These flame retardant additives dedicated to anti-dripping performance can be used in synergy with the flame retardant additives disclosed in this patent. Additionally, the flame retardant additives disclosed in the present patent have demonstrated synergy with other well-known halogen-free additives, such as KSS, Zinc Borates and Metal Hydroxydes (aluminium trihydroxyde or magnesium dihydroxyde). When used as synergists, classical flame retardants such as KSS, Zinc Borates or Metal Hydroxydes (aluminium trihydroxyde or Magnesium dihydroxyde) can be either physically blended or surface pre-treated with the silicon based additives disclosed in this patent prior to compounding.

In a process according to one aspect of the present invention for improving the fire resistance of a thermoplastic, thermoset or rubber organic polymer composition, an alkoxysilane containing at least one organic nitrogen-containing group and an alkoxysilane or silicone resin containing at least one group selected from phosphonate and phosphinate groups are added to a thermoplastic, thermosetting or rubber organic polymer composition and heated to cause hydrolysis and condensation of the alkoxysilane or alkoxysilanes.

In a process according to another aspect of the present invention for improving the fire resistance of a thermoplastic, thermoset or rubber organic polymer composition, characterised in that an alkoxysilane containing at least one group selected from phosphonate and phosphinate groups and a silicone resin containing at least one organic nitrogen-containing group are added to a thermoplastic, thermosetting or rubber organic polymer composition and heated to cause hydrolysis and condensation of the alkoxysilane.

In a process according to another aspect of the present invention for improving the fire resistance of a thermoplastic or thermoset organic polymer composition, characterised in that an alkoxysilane containing at least one group selected from phosphonate and phosphinate groups and at least one organic nitrogen-containing group is added to a thermoplastic or thermosetting organic polymer composition and heated to cause hydrolysis and condensation of the alkoxysilane.

The alkoxysilane hydrolyses into silanol (Si—O—H containing compound) which then condenses into siloxane (Si—O—Si containing compound).

The invention includes the use of an alkoxysilane containing at least one group selected from phosphonate and phosphinate groups and at least one organic nitrogen-containing group in a thermoplastic, thermosetting or rubber organic polymer composition to improve the fire resistance of the organic polymer composition. The invention also includes a polymer composition comprising a thermoplastic or thermosetting organic polymer and an alkoxysilane containing at least one group selected from phosphonate and phosphinate groups and at least one organic nitrogen-containing group.

The invention also includes a polymer composition comprising a thermoplastic, thermosetting or rubber organic polymer, an alkoxysilane containing at least one organic nitrogen-containing group and an alkoxysilane or silicone resin containing at least one group selected from phosphonate and phosphinate groups.

The invention further includes a polymer composition comprising a thermoplastic or thermosetting organic polymer, an alkoxysilane containing at least one group selected from phosphonate and phosphinate groups and a silicone resin containing at least one organic nitrogen-containing group.

Polyorganosiloxanes, also known as silicones, generally comprise siloxane units selected from R₃SiO_{1/2} (M units), R₂SiO_{2/2}(D units), RSiO_{3/2}(T units) and SiO_{4/2}(Q units), in which each R represents an organic group or hydrogen or a hydroxyl group. Q units can be formed by hydrolysis and siloxane condensation of a tetraalkoxysilane. T units can be formed by hydrolysis and siloxane condensation of a trialkoxysilane. D units can be formed by hydrolysis and siloxane condensation of a dialkoxysilane. M units can be formed by hydrolysis and siloxane condensation of a monoalkoxysilane. Branched silicone resins contain T and/or Q units, optionally in combination with M and/or D units.

It is preferred that the polysiloxane which is formed within the thermoplastic, thermosetting or rubber organic polymer composition when the polymer composition is heated to cause hydrolysis and condensation of the alkoxysilane is a branched silicone resin. According to one aspect of the invention it is preferred that the alkoxysilane containing at least one organic nitrogen-containing group and/or the alkoxysilane containing at least one group selected from phosphonate and phosphinate groups is a trialkoxysilane, which will form T units on hydrolysis and condensation. In one particularly preferred aspect of the invention, a trialkoxysilane containing at least one organic nitrogen-containing group and a trialkoxysilane containing at least one group selected from phosphonate and phosphinate groups are added to the thermoplastic, thermosetting or rubber organic polymer composition. Alternatively one of these alkoxysilanes can be a dialkoxysilane or monoalkoxysilane, or both the alkoxysilane containing at least one organic nitrogen-containing group and the alkoxysilane containing at least one group selected from phosphonate and phosphinate groups can be a dialkoxysilane or monoalkoxysilane if they are used in conjunction with a tetraalkoxysilane or trialkoxysilane.

In an alternative aspect of the invention, an alkoxysilane containing at least one organic nitrogen-containing group and a branched silicone resin containing at least one group selected from phosphonate and phosphinate groups, or an alkoxysilane containing at least one group selected from phosphonate and phosphinate groups and a silicone resin containing at least one organic nitrogen-containing group are added to the thermoplastic, thermosetting or rubber organic polymer composition. In this case the alkoysilane is preferably a trialkoxysilane but can alternatively be a dialkoxysilane or monoalkoxysilane.

The alkoxysilane containing at least one organic nitrogen-containing group is preferably a trialkoxysilane of the formula R_{N}Si(OR′)₃ where R_{N} is an alkyl, cycloalkyl, alkenyl, alkynyl or aryl group having 1 to 20 carbon atoms containing an organic nitrogen substituent and each R′ is an alkyl group having 1 to 4 carbon atoms.

One preferred type of nitrogen-containing alkoxysilane according to the invention has the formula

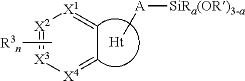

where X¹, X², X³ and X⁴ independently represent a CH group or a N atom and form a benzene, pyridine, pyridazine, pyrazine, pyrimidine or triazine aromatic ring; Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; each R represents an alkyl, cycloalkyl, alkenyl, alkynyl, aryl, aminoalkyl or aminoaryl group having 1 to 20 carbon atoms; each R′ represents an alkyl group having 1 to 4 carbon atoms; a is 0, 1 or 2; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, alkenyl group having 1 to 8 carbon atoms or cycloalkyl, alkynyl, aryl, substituted aryl groups having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring.

The heterocyclic ring Ht is preferably not a fully aromatic ring, i.e. it is preferably not a pyridine, pyridazine, pyrazine, pyrimidine or triazine aromatic ring. The heterocyclic ring Ht can for example be an oxazine, pyrrole, pyrroline, imidazole, imidazoline, thiazole, thiazoline, oxazole, oxazoline, isoxazole or pyrazole ring. Examples of preferred heterocyclic ring systems include benzoxazine, indole, benzimidazole, benzothiazole and benzoxazole. In some preferred alkoxysilanes the heterocyclic ring is an oxazine ring; such alkoxysilanes have the formula

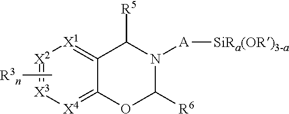

where X¹, X², X³ and X⁴, Ht, A, R, R′, a, R^{3 and n} are defined as above and R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group. The alkoxysilane can for example be a substituted benzoxazine of the formula

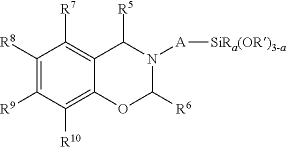

where R⁷, R⁸, R⁹ and R¹⁰ each represent hydrogen, an alkyl, substituted alkyl, alkenyl group having 1 to 8 carbon atoms or cycloalkyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, or R⁷ and R⁸, R⁸ and R⁹ or R⁹ and R¹⁶ can each be joined to form a ring system comprising at least one carbocyclic or heterocyclic ring fused to the benzene ring.

Examples of useful trialkoxysilanes containing a R_{N} group thus include 3-(3-benzoxazinyl)propyltriethoxysilane

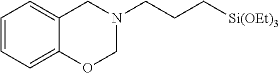

and the corresponding naphthoxazinetriethoxysilane,

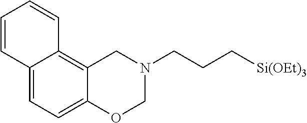

3-(6-cyanobenzoxazinyl-3)propyltriethoxysilane, and

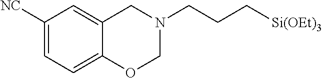

3-(2-phenylbenzoxazinyl-3)propyltriethoxysilane

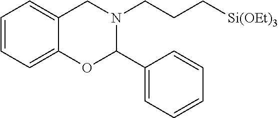

The oxazine or other heterocyclic ring Ht can alternatively be bonded to a pyridine ring to form a heterocyclic group of the formula

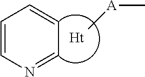

The benzene, pyridine, pyridazine, pyrazine or triazine aromatic ring can be annelated to a ring system comprising at least one carbocyclic or heterocyclic ring to form an extended ring system enlarging the pi-electron conjugation. A benzene ring can for example be annelated to another benzene ring to form a ring system containing a naphthanene moiety

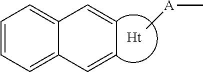

such as a naphthoxazine group, or can be annelated to a pyridine ring to form a ring system containing a quinoline moiety.

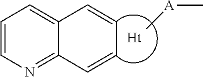

A pyridine ring can for example be annelated to a benzene ring to form a ring system containing a quinoline moiety in which the heterocyclic ring Ht, for example an oxazine ring, is fused to the pyridine ring

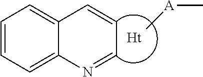

The aromatic ring can be annelated to a quinone ring to form a benzoquinoid or naphthoquinoid structure. In an alkoxysilane of the formula

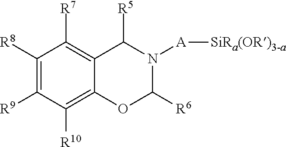

the groups R⁸ and R⁹, R⁷ and R⁸, or R⁹ and R¹⁰ can form an annelated ring of benzoquinoid or naphthoquinoid structure. Such ring systems containing carbonyl groups may have improved solubility in organic solvents, allowing easier application to polymer compositions.

The alkoxysilane containing at least one organic nitrogen-containing group can be a bissilane containing two heterocyclic rings each having an alkoxysilane substituent. The heterocyclic rings can for example each be bonded to separate aromatic rings which are chemically bonded to each other. The aromatic rings can for example be bonded by a direct bond

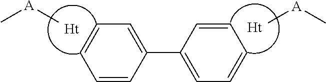

or can be bonded by a divalent organic group

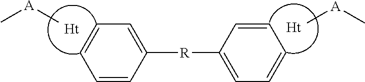

For example in an alkoxysilane of the formula

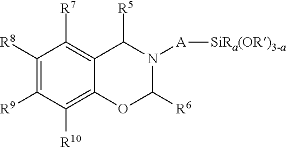

where A, R, R′, a, R⁵ and R⁶ are each defined as above, one group selected from R⁷, R⁸, R⁹ and R¹⁰ represents an alkyl group substituted by a group of the formula

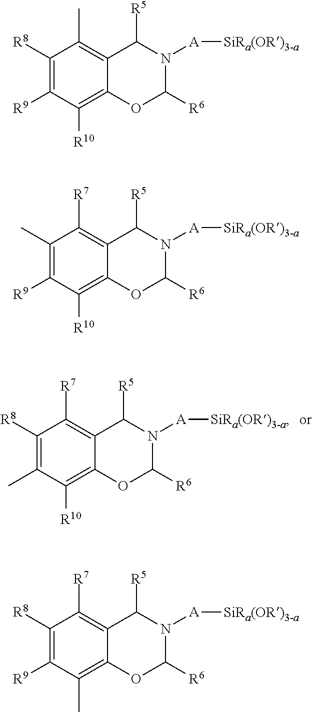

where A, R, R′, a, R⁵ and R⁶ are each defined as above. The remaining groups of R⁷, R⁸, R⁹ and R¹⁰ in each ring can each represent hydrogen, an alkyl, substituted alkyl, alkenyl group having 1 to 8 carbon atoms or cycloalkyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms; An example of such a bissilane is 1,3-bis(3-(3-trimethoxysilylpropyl)benzoxazinyl-6)-2,2-dimethylpropane

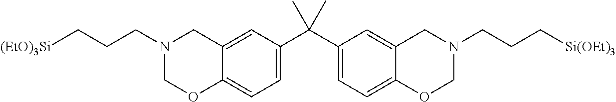

The heterocyclic rings Ht, for example oxazine rings, in a bissilane can alternatively both be fused to the same aromatic ring

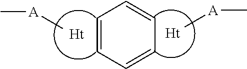

The aromatic ring can optionally be annelated to a further ring system comprising at least one carbocyclic or heterocyclic ring

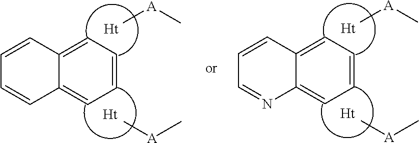

The heterocyclic rings Ht having a -A-SiRₐ(OR′)₃₋ₐ substituent can be fused to different rings of an annelated aromatic ring system such as quinoline or naphthalene

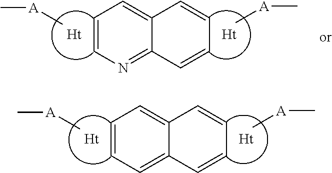

A bissilane can have heterocyclic rings, each having a -A-SiRₐ(OR′)₃₋ₐ substituent, fused to the same aromatic ring of an annelated naphthoquinoid or anthraquinoid structure, for example

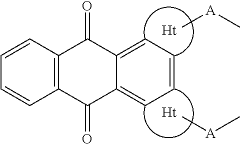

In an anthraquinoid structure the heterocyclic rings, each having a -A-SiRₐ(OR′)₃₋ₐ substituent, can be fused to the first and second rings of the anthraquinoid structure

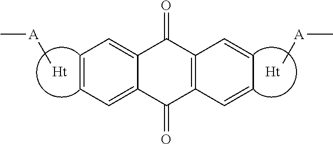

The alkoxysilane containing at least one organic nitrogen-containing group can alternatively contain an aminoalkyl or aminoaryl group containing 1 to 20 carbon atoms and 1 to 3 nitrogen atoms bonded to a silicon atom of the silicone resin, for example —(CH₂)₃NH₂, —(CH₂)₄NH₂, —(CH₂)₃NH(CH₂)₂NH₂, —CH₂CH(CH₃)CH₂NH₂, —CH₂CH(CH₃)CH₂NH(CH₂)₂NH₂, —(CH₂)₃NHCH₂CH₂NH(CH₂)₂NH₂, —CH₂CH(CH₃)CH₂NH(CH₂)₃NH₂, —(CH₂)₃NH(CH₂)₄NH₂ or —(CH₂)₃—O(CH₂)₂NH₂. or —(CH₂)₃NHC₆H₄, —(CH₂)₃NH(CH₂)₂NHC₆H₄, —(CH₂)₃NHCH₃, —(CH₂)₃N(C₆H₄)₂.

The alkoxysilane containing at least one organic nitrogen-containing group can for example be 3-aminopropyltrimethoxysilane.

The alkoxysilane containing at least one group selected from phosphonate and phosphinate groups is preferably a trialkoxysilane of the formula R_{P}Si(OR′)₃ where R_{P} is an alkyl, cycloalkyl, alkenyl, alkynyl or aryl group having 1 to 20 carbon atoms containing a phosphonate or phosphinate substituent and each R′ is an alkyl group having 1 to 4 carbon atoms. The group R_{P} can for example have the formula

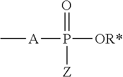

where A is a divalent hydrocarbon group having 1 to 20 carbon atoms and R* is an alkyl or aryl group having 1 to 12 carbon atoms. If the group R_{P} contains a phosphonate substituent, Z is preferably a group of the formula —OR*. If the group R_{P} contains a phosphinate substituent, Z is preferably an alkyl, cycloalkyl, alkenyl, alkynyl or aryl group having 1 to 20 carbon atoms. Preferred groups R_{P} include 2-(diethylphosphonato)ethyl, 3-(diethylphosphonato)propyl, 2-(dimethylphosphonato)ethyl, 3-(dimethylphosphonato)propyl, 2-(ethyl(ethylphosphinato))ethyl and 3-(ethyl(ethylphosphinato))propyl.

The phosphinate substituent can alternatively comprise a DOPO group. The group R_{P} can for example have the formula

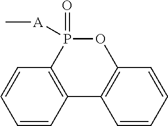

where A² is a divalent hydrocarbon group having 1 to 20 carbon atoms, for example 2-DOPO-ethyl or 3-DOPO-propyl.

Examples of useful trialkoxysilanes containing a R_{P} group thus include 2-(diethylphosphonato)ethyltriethoxysilane, 3-(diethylphosphonato)propyltriethoxysilane and 2-(DOPO)ethyltriethoxysilane.

Where an alkoxysilane containing at least one group selected from phosphonate and phosphinate groups and at least one organic nitrogen-containing group is used according to the invention in a thermoplastic or thermosetting organic polymer composition to improve the fire resistance of the organic polymer composition, the alkoxysilane can preferably be a trialkoxysilane of the formula RbSi(OR′)₃, in which Rb is an alkyl, cycloalkyl, alkenyl, alkynyl or aryl group having 1 to 20 carbon atoms containing both a phosphonate or phosphinate substituent and an organic nitrogen group. Examples of groups of the formula Rb are groups of the formula

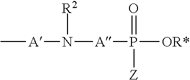

where A′ is a divalent organic group having 1 to 20 carbon atoms, A″ is a divalent organic group having 1 to 20 carbon atoms, R* is an alkyl group having 1 to 12 carbon atoms and Z is a group of the formula —OR* or an alkyl, cycloalkyl, alkenyl, alkynyl or aryl group having 1 to 12 carbon atoms, or R* and Z can be joined to form a heterocylic ring, and R² is hydrogen or an alkyl, cycloalkyl, alkenyl, alkynyl or aryl group having 1 to 12 carbon atoms, or can be joined to A″ to form a heterocyclic ring. Examples of such trialkoxysilanes containing a group Rb are 3-(2-phosphonatoethylamino)propyl triethoxysilane,

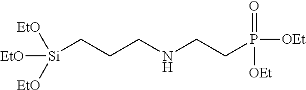 [SMILES: CCO[Si](CCCNCCP(=O)(OCC)OCC)(OCC)OCC]

3-(2-phosphonatoethylamino)propyl trimethoxysilane, 3-(2-(2-phosphonatoethylamino)ethylamino)propyl triethoxysilane

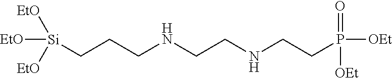 [SMILES: CCO[Si](CCCNCCNCCP(=O)(OCC)OCC)(OCC)OCC]

and 3-(2-DOPO-ethylamino)propyl triethoxysilane. The alkoxysilane containing at least one group selected from phosphonate and phosphinate groups and at least one organic nitrogen-containing group can alternatively be an alkoxysilane-substituted nitrogen-containing heterocyclic compound, such as a benzoxazine alkoxysilane having a phosphonate substituent

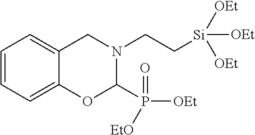 [SMILES: CCO[Si](CCN1Cc2ccccc2OC1P(=O)(OCC)OCC)(OCC)OCC]

or a DOPO substituent

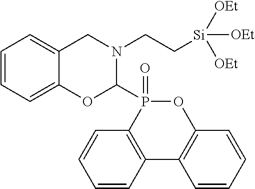 [SMILES: CCO[Si](CCN1Cc2ccccc2OC1P1(=O)Oc2ccccc2-c2ccccc21)(OCC)OCC]

The alkoxysilane containing at least one organic nitrogen-containing group and alkoxysilane or silicone resin containing at least one group selected from phosphonate and phosphinate groups, or the alkoxysilane containing at least one group selected from phosphonate and phosphinate groups and silicone resin containing at least one organic nitrogen-containing group, or the alkoxysilane containing at least one group selected from phosphonate and phosphinate groups and at least one organic nitrogen-containing group, can optionally be added to the thermoplastic, thermosetting or rubber organic polymer composition in conjunction with a tetraalkoxysilane and/or a trialkoxysilane which does not contain a R_{N} or R_{P} group. A tetraalkoxysilane may have the formula Si(OR′)₄ where each R′ is an alkyl group having 1 to 4 carbon atoms. An example of a useful tetraalkoxysilane is tetraethoxysilane. A trialkoxysilane may have the formula R⁴Si(OR′)₃, in which each R′ is an alkyl group having 1 to 4 carbon atoms and R⁴ represents an alkyl, cycloalkyl, alkenyl, alkynyl or aryl group having 1 to 20 carbon atoms. Examples of useful trialkoxysilanes of the formula R⁴Si(OR′)₃ are alkyltrialkoxysilanes such as methyltriethoxysilane, ethyltriethoxysilane, methyltrimethoxysilane and aryltrialkoxysilanes such as phenyltriethoxysilane. The tetraalkoxysilane and/or trialkoxysilane which does not contain a R_{N} or R_{P} group can for example be present at 0 to 500% based on the total weight of alkoxysilane(s) and silicone resin containing an organic nitrogen-containing group and/or a group selected from phosphonate and phosphinate groups.

Alternative alkoxysilanes containing a phosphonate or phosphinate group are monoalkoxysilanes for example of the formula R_{P}R¹¹₂SiOR′ and dialkoxysilanes for example of the formula R_{P}R¹¹Si(OR′)₂, where each R′ is an alkyl group having 1 to 4 carbon atoms; each R_{P} is an alkyl, cycloalkyl, alkenyl, alkynyl or aryl group having 1 to 20 carbon atoms containing a phosphonate or phosphinate substituent; and each R¹¹ which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing a phosphonate or phosphinate substituent. Examples of suitable monoalkoxysilanes containing a phosphonate or phosphinate group are 2-(DOPO)ethyldimethylethoxysilane and 3-(diethylphosphonato)propyldimethylethoxysilane. Examples of suitable dialkoxysilanes containing a phosphonate or phosphinate group are 2-(DOPO)ethylmethyldiethoxysilane and 3-(diethylphosphonato)propylmethyldiethoxysilane.

Alternative alkoxysilanes containing an organic nitrogen-containing group are monoalkoxysilanes for example of the formula R_{N} R¹²₂SiOR′ and dialkoxysilanes for example of the formula R_{N}R¹²Si(OR′)₂ where each R_{N} is an alkyl, cycloalkyl, alkenyl, alkynyl or aryl group having 1 to 20 carbon atoms containing an organic nitrogen substituent; and each R¹² which can be the same or different is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing an organic nitrogen substituent. Examples of suitable monoalkoxysilanes containing an organic nitrogen substituent are 3-(3-benzoxazinyl)propyldimethylethoxysilane and 3-aminopropyldimethylethoxysilane. Examples of suitable dialkoxysilanes containing an organic nitrogen substituent are 3-(3-benzoxazinyl)propylmethyldiethoxysilane and 3-aminopropylmethyldimethoxysilane.

An alternative example of an alkoxysilane containing both a phosphonate or phosphinate group and an organic nitrogen-containing group is a monoalkoxysilane or dialkoxysilane of the formula RbR¹³Si(OR′)₂ or RbR¹³₂SiOR′, where each R′ is an alkyl group having 1 to 4 carbon atoms, each Rb is an alkyl, cycloalkyl, alkenyl, alkynyl or aryl group having 1 to 20 carbon atoms containing both a phosphonate or phosphinate substituent and an organic nitrogen group; and each R¹³ is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing a phosphonate or phosphinate substituent and/or an organic nitrogen group.

Further examples of alkoxysilanes containing both a phosphonate or phosphinate group and an organic nitrogen-containing group include dialkoxysilanes of the formula R_{P}R_{N}Si(OR′)₂ and monoalkoxysilanes of the formula R_{P}R_{N}R¹³SiOR′, where each R′ is an alkyl group having 1 to 4 carbon atoms; each R_{P} is an alkyl, cycloalkyl, alkenyl, alkynyl or aryl group having 1 to 20 carbon atoms containing a phosphonate or phosphinate substituent; each R_{N} is an alkyl, cycloalkyl, alkenyl, alkynyl or aryl group having 1 to 20 carbon atoms containing an organic nitrogen substituent; and each R¹³ is an alkyl, cycloalkyl, alkenyl, alkynyl or aryl group having 1 to 20 carbon atoms or an alkyl, cycloalkyl, alkenyl, alkynyl or aryl group having 1 to 20 carbon atoms containing a phosphonate or phosphinate substituent or an organic nitrogen substituent. Examples of dialkoxysilanes include 2-DOPO-ethyl 3-aminopropyl dimethoxy silane and 3-(diethylphosphonato)propyl 3-(3-benzoxazinyl)propyl dimethoxy silane. Examples of monoalkoxysilanes include 2-DOPO-ethyl 3-aminopropyl methyl methoxy silane and 3-(diethylphosphonato)propyl 3-(3-benzoxazinyl)propyl methyl methoxy silane.

If a monoalkoxysilane or dialkoxysilane containing a R_{N} group, a Rb group and/or a R_{P} group is used in the present invention, it is preferably added to the thermoplastic, thermosetting or rubber organic polymer composition together with at least one trialkoxysilane and/or tetraalkoxysilane so that when the alkoxysilanes are hydrolysed they will condense to form a branched silicone resin within the polymer composition. A monoalkoxysilane or dialkoxysilane containing a R_{P} group can be used with a trialkoxysilane containing a R_{N} group, and optionally another trialkoxysilane and/or a tetraalkoxysilane. A monoalkoxysilane or dialkoxysilane containing a R_{N} group can be used with a trialkoxysilane containing a R_{P} group, and optionally another trialkoxysilane and/or a tetraalkoxysilane. Alternatively a monoalkoxysilane or dialkoxysilane containing a R_{P} group can be reacted with a monoalkoxysilane or dialkoxysilane containing a R_{N} group and a tetraalkoxysilane and/or a trialkoxysilane which does not contain a R_{N} or R_{P} group. Suitable trialkoxysilanes are those of the formula R¹¹Si(OR′)₃ described above.

If a silicone resin containing at least one group selected from phosphonate and phosphinate groups is used in the present invention, it is preferably a branched silicone resin in which at least 25% and more preferably at least 50% of the siloxane units in the branched silicone resin are T and/or Q units. Such a silicone resin can for example comprise T units formed by hydrolysis and condensation of a trialkoxysilane of the formula R_{P}Si(OR′)₃ as described above, optionally with a tetraalkoxysilane or a trialkoxysilane, for example a trialkoxysilane of the formula R¹¹Si(OR′)₃ as described above or a trialkoxysilane of the formula R_{N}Si(OR′)₃ as described above. The silicone resin can alternatively be formed by hydrolysis and condensation of a monoalkoxysilane of the formula R_{P}(R₉)₂SiOR′ or a dialkoxysilane of the formula RpR₉Si(OR′)₂ with a tetraalkoxysilane or a trialkoxysilane.

If a silicone resin containing at least one organic nitrogen-containing group is used in the present invention, it is preferably a branched silicone resin in which at least 25% and more preferably at least 50% of the siloxane units in the branched silicone resin are T and/or Q units. Such a silicone resin can for example comprise T units formed by hydrolysis and siloxane condensation of a trialkoxysilane of the formula RnSi(OR′)₃ as described above, optionally with a tetraalkoxysilane or a trialkoxysilane, for example a trialkoxysilane of the formula R⁴Si(OR′)₃ as described above or a trialkoxysilane of the formula R_{P}Si(OR′)₃ as described above. The silicone resin can alternatively be formed by hydrolysis and condensation of a monoalkoxysilane of the formula R_{N}(R₁₂)₂SiOR′ or a dialkoxysilane of the formula R_{N}R₁₂Si(OR′)₂ with a tetraalkoxysilane or a trialkoxysilane.

The ratio of organic nitrogen-containing groups in the alkoxysilane containing at least one organic nitrogen-containing group to phosphonate or phosphinate groups in the alkoxysilane or silicone resin containing at least one group selected from phosphonate and phosphinate groups can vary within a wide range. Similarly the ratio of phosphonate or phosphinate groups in the alkoxysilane containing at least one group selected from phosphonate and phosphinate groups to organic nitrogen-containing groups in the silicone resin containing at least one organic nitrogen-containing group, and the ratio of phosphonate or phosphinate groups to organic nitrogen-containing groups in the alkoxysilane containing at least one group selected from phosphonate and phosphinate groups and at least one organic nitrogen-containing group, can vary within a wide range. The molar ratio of phosphorus to nitrogen in the total alkoxysilane(s) and silicone resin added to the thermoplastic or thermoset organic polymer composition can for example be in the range 1:9 to 9:1.

The alkoxysilane(s) and silicone resin can for example be added to a thermoplastic, thermoset or rubber organic polymer composition according to the invention in amounts ranging from 0.1 or 0.5% by weight total alkoxysilane(s) and silicone resin up to 50 or 75%. Preferred amounts may range from 0.1 to 25% by weight alkoxysilane(s) and silicone resin in thermoplastic and rubber compositions such as polycarbonates, and from 0.2 to 75% by weight alkoxysilane(s) and silicone resin in thermosetting compositions such as epoxy resins.

The alkoxysilane(s), and silicone resin if present, are heated in the presence of thermoplastic, thermosetting or rubber organic polymer composition and in the presence of moisture or hydroxyl groups to cause hydrolysis and siloxane condensation of the alkoxysilane or alkoxysilanes. It is generally not necessary to deliberately add moisture to achieve hydrolysis. Atmospheric moisture is often sufficient to cause hydrolysis of the alkoxysilane(s). Moisture present in the organic polymer, for example on the surface of thermoplastic polymer particles such as polycarbonate pellets, is often sufficient. If the polymer composition contains a filler such as silica, moisture or hydroxyl groups present at the surface of the filler is generally sufficient for hydrolysis. Alternatively water can be added with the alkoxysilane(s), and silicone resin if present. Water can for example be added in an approximately stoichiometric amount with respect to the Si-bonded alkoxy groups of the alkoxysilane(s), for example 0.5 to 1.5 moles water per alkoxy group.

Heating can be carried out simultaneously with the addition of the alkoxysilane(s) or subsequent to the addition of the alkoxysilane(s). In a preferred process, mixing with the thermoplastic, thermosetting or rubber organic polymer composition takes place at an elevated temperature above the glass transition temperature of the polymer and preferably above the softening temperature of the polymer. Mixing can for example take place at a temperature in the range 50 to 300° C. Mixing can for example be carried out continuously in an extruder, which can be an extruder adapted to knead or compound the materials passing through it such as a twin screw extruder or can be a more simple extruder such as a single screw extruder. A batch mixing process can for example be carried out in an internal mixer such as a Brabender Plastograph (Trade Mark) 350S mixer equipped with roller blades, or a Banbury mixer. A roll mill can be used for either batch or continuous processing.

We believe that when an alkoxysilane containing at least one organic nitrogen-containing group and an alkoxysilane containing at least one group selected from phosphonate and phosphinate groups, or an alkoxysilane containing at least one group selected from phosphonate and phosphinate groups and at least one organic nitrogen-containing group, are heated in a thermoplastic, thermosetting or rubber organic polymer composition in the presence of moisture to cause hydrolysis and condensation of the alkoxysilane or alkoxysilanes, a silicone resin containing organic nitrogen-containing groups and phosphonate and phosphinate groups is formed within the organic polymer composition. We have found that the polymer compositions to which the alkoxysilanes have been added have improved thermal stability, as shown by thermogravimetric (TGA) analysis, and better flame retardancy properties, as shown by TGA and the UL-94 test, and/or other flammability tests such as the glow wire test or cone calorimetry.

We believe that when an alkoxysilane containing at least one organic nitrogen-containing group and a silicone resin containing at least one group selected from phosphonate and phosphinate groups, or an alkoxysilane containing at least one group selected from phosphonate and phosphinate groups and a silicone resin containing at least one organic nitrogen-containing group, are heated in a thermoplastic, thermosetting or rubber organic polymer composition in the presence of moisture to cause hydrolysis and siloxane condensation of the alkoxysilane, some interaction of the alkoxysilane with the silicone resin takes place so that T units from the alkoxysilane are incorporated into the silicone resin. We have found that the polymer compositions to which the alkoxysilane and silicone resin have been added have improved thermal stability and better flame retardancy properties.

The alkoxysilane(s), and silicone resin if used, can be incorporated according to the invention into a wide range of thermoplastic resins, for example polycarbonates, ABS (acrylonitrile butadiene styrene) resins, polycarbonate/ABS blends, polyesters, polystyrene, or polyolefins such as polypropylene or polyethylene. The alkoxysilane(s), and silicone resin if used, can also be incorporated into thermosetting resins, for example epoxy resins of the type used in electronics applications, which are subsequently thermoset, or unsaturated polyester resin. The alkoxysilane(s), and silicone resin if used, can also be incorporated into a wide range of rubbers such as natural or synthetic rubbers. The alkoxysilanes, or alkoxysilane(s) and silicone resin, of the invention are particularly effective in increasing the fire resistance of polycarbonates and blends of polycarbonate with other resins such as polycarbonate/ABS blends. Such polycarbonates and blends are moulded for use in, for example, the interior of transportation vehicles, in electrical applications as insulators and in construction. Unsaturated polyester resins, or epoxy are moulded for use in, for example, the nacelle of wind turbine devices. Normally, they are reinforced with glass (or carbon) fibre cloth; however, the use of a flame retardant additive is important for avoiding fire propagation.

The polymer compositions of the invention can alternatively be used as a fire resistant coating. Such coatings can be applied to a wide variety of substrates including plastics, textile, paper, metal and wood substrates, and are particularly effective when applied to structural elements such as walls, columns, girders and lintels as the resin containing nitrogen and phosphorus formed by the reaction of alkoxysilane(s) after adding to the composition forms an expanded char when exposed to a fire and foams, behaving as an intumescent material upon exposure to fire. This expanded (foamed) char acts as an insulating material which limits transfer of heat to adjacent rooms in a fire and protects structural elements so that they do not reach a temperature at which they are weakened, or reach that temperature more slowly. For use in coatings the thermoplastic, rubber or thermosetting organic polymer is preferably a film-forming binder such as an epoxy resin, a polyurethane or an acrylic polymer. The silanes of the invention, or the resins when dissolved in an appropriate solvent, can alternatively be used as a fire resistant coating. Such silanes, or dissolved resins can be applied by dip-, spin-, spray-coating, etc. on a wide variety of substrates (plastics, textiles, paper, metal, wood, cork, etc.), or as fibre sizing agents, or in filler (aluminium tetrahydrate, ATH, magnesium dihydrate, MDH) treatment, or in carbon nanotube functionalisation, etc. Atmospheric moisture is often sufficient to cause hydrolysis of the alkoxysilane(s). Otherwise water, other OH species or OH releasing groups can be added to the alkoxysilane prior to the coating process. Hydrolysis and condensation reactions may be promoted at that stage by adding a catalyst, such as an acid or base, and/or by heating the silane solution to 20-70° C. The sol-gel method can be employed in this case.

The polymer compositions of the invention can contain additives such as fillers, pigments, dyes, plasticisers, adhesion promoters, coupling agents, antioxidants, impact resistants, hardeners (e.g. for anti-scratch) and/or light stabilisers.

In particular the polymer compositions of the invention can contain a reinforcing filler such as silica. The silica is preferably blended with the alkoxysilane(s), and silicone resin if used, before the alkoxysilane(s) and silicone resin are added to the thermoplastic, thermoset or rubber organic polymer composition. When the alkoxysilane is heated with the silica in the thermoplastic, thermoset or rubber organic polymer composition, some bonding may take place between the alkoxysilane and the silica. The silica can for example be present at 0.1 or 0.5% by weight up to 40 or 60% by weight of the thermoplastic, thermoset or rubber organic polymer composition, and can be present at 1 to 500% based on the total weight of alkoxysilane(s) and silicone resin if used.

The polymer compositions of the invention can contain a silicone gum, that is a high molecular weight substantially linear polydiorganosiloxane. The silicone gum can for example be a polydimethylsiloxane of viscosity at least 60,000 centiStokes, particularly above 100,000 cSt, and may have a viscosity as high as 30,000,000 cSt. The silicone gum is preferably blended with the alkoxysilane(s), and silicone resin if used, before the alkoxysilane(s) and silicone resin are added to the thermoplastic or thermoset organic polymer composition. The silicone gum can for example be present at 0.1 or 0.5% by weight up to 20 or 30% by weight of the thermoplastic or thermoset organic polymer composition, and can be present at 1 to 100% by weight based on the total weight of alkoxysilane(s) and silicone resin. The silicone gum acts as a plasticiser for the silicone resin formed by hydrolysis and condensation of the alkoxysilane(s) and may increase the flexural strength of the resulting polymer compositions.

If silica is incorporated in compositions comprising the alkoxysilane(s) as described above, it can be gum-coated silica. An example of gum-coated silica is sold by Dow Corning under the trademarks DC4-7051 and DC4-7081 as a resin modifier for silicone resins.

The invention is illustrated by the following Examples, in which parts and percentages are by weight, and will be described with reference to the accompanying drawings, of which

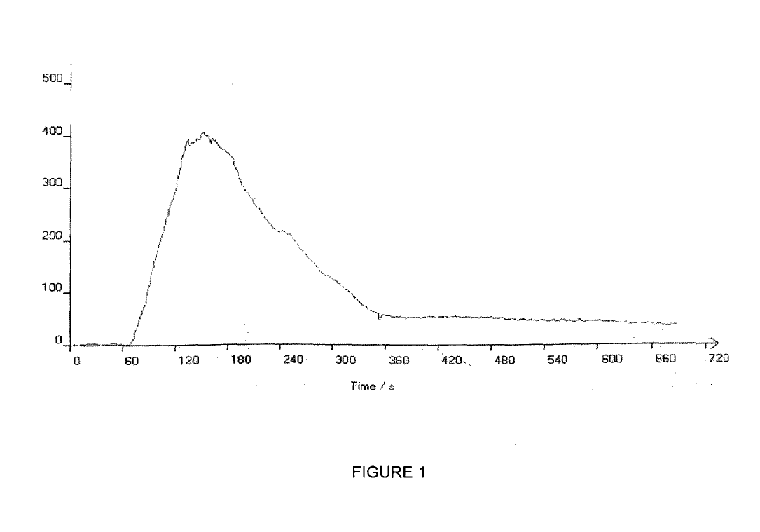

FIG. 1 is a cone calorimetry plot of heat release rate against time for the composition of Example 1; and

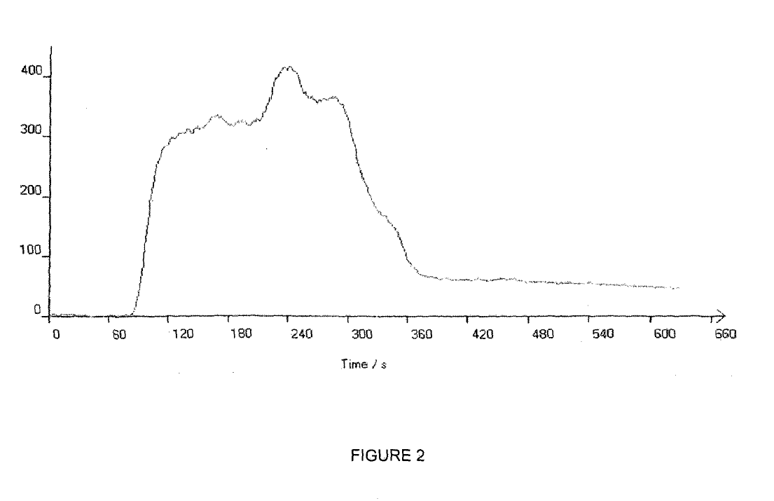

FIG. 2 is a cone calorimetry plots of heat release rate against time for a comparison composition.

### PREPARATION EXAMPLES

### A—Synthesis of Benzoxazine Triethoxysilane

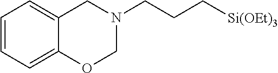

15.015 g of paraformaldehyde (500 mmole of H2C═O), 17.75 g of sodium sulfate powder (125 mmole) and 100 ml ethanol were charged to a 1 litre 3-necked flask and stirred (magnetic stirrer). 55.343 g of aminopropyltriethoxysilane, APTES (Z-6011; 250 mmole) were weighed with 100 ml of ethanol into a dropping funnel and added under vigorous stirring to the formaldehyde solution at room temperature (exothermic). The mixture was then heated to around 60 degrees C. for 10 minutes. Then 23.63 g of phenol in 200 ml ethanol were added drop wise over about 1 h. Then the complete mixture was heated up to reflux temperature of ethanol and stirred for 5 hours. The ethanol was stripped off by rotary evaporation.

### B—Preparation of Trialkoxysilane Containing Cyclic Phosphinate Group (DOPO Silane)

In a reaction flask heated up at 80° C., under inert atmosphere (N₂ pressure), 3 gr vinyl triethoxysilane (0.0157 mol) are introduced, followed by 3.39 gr (0.0157 mol) of DOPO (9,10-Dihydro-9-Oxa-10-Phosphaphenanthrene-10-Oxide). Finally, 0.26 gr of AIBN (0.00157 mol) was added and the reaction mixture stirred at 80° C. for 16 hours. The reaction was cooled down and the crude 2-DOPO-ethyltriethoxysilane product analyzed by ²⁹Si NMR. It clearly shows the disappearance of the vinyl functionality and the formation of the Si—CH2-CH2-P bond.

### C—Synthesis of DOPO Silicone Resin

A 250 ml 3 necked round bottom flask equipped with a magnetic stir bar, thermometer and a water-cooled condenser, was loaded with phenyltriethoxysilane (65.2 gr, 0.27 mols Si), 2-DOPO-ethyltriethoxysilane (47.2 gr, 0.116 mols Si) and diethyl ketone (37.37 gr, 25% wt diethyl ketone). Reaction was stirred at 75° C. and 18.25 gr of deionised water was added slowly. The reaction was stirred at 79° C. for 2 hours and the reaction mixture was clear light yellow. The solvent was evaporated under low pressure and the residue was dissolved again in 20 gr diethyl ketone. Solvent was eliminated under reduced pressure again during 4 hours (50° C.) in order to obtain a resin as a brittle slight yellow solid. The resin was characterized by ²⁹Si NMR and proved the formation of the ⁷⁰T(Ph)³⁰T(DOPO) silicone resin with no residual alkoxy groups and a Si—OH content of 4.6% mol.

### D—Synthesis of Methoxy-Benzoxazine Triethoxysilane

A 1 L flask fitted with a nitrogen valve, condenser and dropping funnel was purged with nitrogen. A portion of paraformaldehyde (30.03 g, 1 mole) in ethanol (200 ml) was charged to the reaction flask and stirred. The dropping funnel was then charged with aminopropyltriethoxysilane Z-6011 (110.69) in ethanol (100 ml) before adding the solution dropwise to the reaction flask at room temperature over a period of around 30 min. Once the addition of the aminopropyltriethoxysilane was complete (slight exotherm reaction) another 200 ml of ethanol were added and the reaction temperature was raised to 65° C. 4-Methoxyphenol (62.07 g, 500 mmole) in ethanol (250 ml) was then charged to the dropping funnel and the mixture was added dropwise to the flask. The reaction was stirred at 65° C. for around 4 hours. Hereby the slightly milky solution completely cleared up. Once the mixture was cooled down the solvent was stripped off using a rotary evaporator ensuring that the heating bath temperature does not increase above 45° C. Around 185-187 g of a viscous, slightly yellow liquid were received.

### E—Synthesis of DOPO Siloxane Resin. T^{DOPO}₃₀T^{PH}₅₀T^{Me}₂₀

In a reactor equipped with condenser, KPG stirrer and distillation unit, 148.5 g of Phenyltrimethoxysilane (0.75 mol), 40.8 g of methyltrimethoxysilane (0.3 mol), 182.7 g (0.45 mol) of DOPO-triethoxysilane were mixed under vigorous stirring. Then 33.75 g of distilled water were added and the mixture was heated under stirring to 80 degrees C. for 1 h. Then the reflux condenser was removed and replaced with the distillation condenser which is connected to a diaphragm pump system. A vacuum of 450 mbar was slowly applied while the distillation of methanol was started. The temperature of the vessel was raised to around 110 deg C. for around 3 h and methanol removed until the distillation temperature finally dropped. While still warm (at around 100 deg C.) the highly viscous colourless material was poured into a HDPE container for storage. Around 288 g of a finally nearly glassy material were received.

### F—Synthesis of DOPO-Aryl Amino Silane

In a 250 ml flask, equipped with a nitrogen inlet, a condenser, and a magnetic stirrer, 13.26 gr (0.06 mol, 1 eq) of Aminopropyltriethoxysilane (Z-6011), 7.32 g (0.06 mol, 1 eq) of 2-hydroxybenzaldehyde, 12.96 gr (0.06 mol, 1 eq) DOPO and 120 gr methanol were mixed together. The reaction mixture was stirred at room temperature for 12 h. After, 4.92 g (0.06 mol, 1 eq) of 37% formaldehyde was added and the mixture was stirred at room temperature for 6 h and finally refluxed for a further 12 h. The methanol solution was cooled down and the product was drummed off.

### Example 1

14.65 g of the DOPO silane prepared in Preparation Example B and 4.05 g of the benzoxazine silane prepared in Preparation Example A were added to 300 g of polycarbonate in an internal mixer compounder at 270° C. The residence time in the mixer was 8 minutes. The matter obtained was pressed in a hot press machine at 250° C. and 100 MPa.

The composition of Example 1 was subjected to flash thermogravimetric analysis in which the sample was heated to 500° C. at a heating rate of 300° C. per minute and held at 500° C. for 20 minutes. This test simulates exposure of the composition to a fire. The residue remaining after 20 minutes at 500° C. was 71.4%, indicating formation of a large amount of ceramic char. By comparison, a sample of the polycarbonate with only the benzoxazine silane had a residue of 38.4% after 20 minutes at 500° C., and the polycarbonate without any silane additive had a residue of 11.7% after 20 minutes at 500° C.

The composition of Example 1 was also analysed by cone calorimetry (ISO 5660 Part 1). The apparatus consists essentially of a conical electric heater delivering uniform radiance to the sample. A spark is used to ignite flammable vapours at the surface of the sample and air passes through the apparatus. The heat released by the sample is measured.

FIG. 1 is a plot of heat release rate in kWm⁻² against time in seconds for the composition of Example 1. This plot indicates charring behaviour. There is an initial increase in heat release rate until a char layer is formed. As the char layer thickens this results in a decrease in heat release rate. The overall heat release rate was 124 kWm⁻²

The polycarbonate without any silane additive was analysed by cone calorimetry under the same conditions. FIG. 2 is a plot of heat release rate in kWm⁻² against time in seconds for the polycarbonate. This plot indicates non-charring behaviour, with a relatively steady heat release rate. The overall heat release rate was 171 kWm⁻²

The cone calorimetry experiments show strong intumescing behaviour by the composition of Example 1 with a consequent improvement in fire control. The lower heat release rate correlates with lower fire spread and fire growth.

### Example 2

DEN 438 (novolak epoxy resin without bromine, 85% solid resin, from Dow Chemicals) was mixed with dicyandiamide at 2.4% and 2-methylimidazole at 0.44%. To this mixture were added 6.5% of the benzoxazine silane prepared in Preparation Example A and 6.5% of the DOPO silicone resin prepared in Preparation Example C. The composition was placed in an Al dish and cure at 190° C. for 1 h 30 min (with heating and cooling rate at 3° C./min). The resulting cured composition had a glass transition temperature Tg of 162° C. (compared to 121° C. for the cured epoxy resin without the silane additives), a Si content of 0.91% and a N content of 0.24%.

A 0.7 mm. thick sheet was prepared from the cured epoxy composition and was subjected to the UL-94 Vertical Burn test in which a flame is applied to the free end of a 120 mm×12 mm sample. The sample was self-extinguishing with a flaming time of 14.5 seconds and did not exhibit dripping.

### Comparative Examples C1 to C4

Example 2 was repeated replacing the benzoxazine silane and DOPO silicone resin by the following materials:

C1—45% benzoxazine monomer

C2—45% of the benzoxazine silane prepared in Preparation Example A

C3—13% of the benzoxazine silane prepared in Preparation Example A

C4—13% of the DOPO silicone resin prepared in Preparation Example C

C5—reference sample with no additive.

In the UL-94 test, reference sample C4 exhibited dripping. None of the other samples exhibited any dripping effect. The flaming time (t1) for each Comparative Example was

C1—18 seconds

C2—15 seconds

C3—26 seconds

C4—23 seconds

C5—35 seconds

It can be seen that the blend of benzoxazine silane with DOPO silicone resin of Example 2 gave a flame retardance performance which was significantly better (shorter flaming time) than for the comparative examples with a single component of those 14.5 s (for 6.5 wt % Bz silane+6.5 wt % DOPO Si resin) versus 26 s for 13 wt % of Bz silane and 23 s for 13 wt % DOPO Si resin. We believe that this shows the synergy of using a nitrogen-containing alkoxysilane and a phosphorus-containing alkoxysilane or silicone resin together in a polymer composition.

### Example 3

### Preparation of PC+0.5 wt % Methoxy-Benzoxazine triethoxysilane+2.5 wt % T^{DOPO}₃₀T^{Ph}₅₀T^{Me}₂₀

2.13 g of the Methoxy-Benzoxazine triethoxysilane prepared in Preparation Example D and 6.47 g of the DOPO siloxane resin T^{DOPO}₃₀T^{Ph}₅₀T^{Me}₂₀ prepared in Preparation Example E were added to 313 g of polycarbonate in an internal mixer compounder at 270° C. The residence time in the mixer was 8 minutes. The matter obtained was pressed in a hot press machine at 250° C. and 100 MPa.

The composition of Example 3 was subjected to the UL-94 Vertical Burn test in which a flame is applied to the free end of a 120 mm×12 mm sample. The sample was self-extinguishing with a flaming time (average t1) of 2 seconds and did not exhibit dripping (UL-94 V0 rating at 1.5 mm).

The composition of Example 3 was also analysed by cone calorimetry (ISO 5660 Part 1).

### Example 4

### Preparation of PC+0.5 wt % Methoxy-Benzoxazine triethoxysilane+2.5 wt % T^{DOPO}₃₀T^{Ph}₅₀T^{Me}₂₀+0.5 wt % potassium diphenylsulfone sulfonate (KSS)

9.63 g of the Methoxy-Benzoxazine triethoxysilane blended with DOPO siloxane resin T^{DOPO}₃₀T^{Ph}₅₀T^{Me}₂₀ prepared in Preparation Example D and E, respectively, were added to 313 g of polycarbonate, together with 1.61 g of KSS, in an internal mixer compounder at 270° C. The residence time in the mixer was 8 minutes. The matter obtained was pressed in a hot press machine at 250° C. and 100 MPa.

The composition of Example 4 was also analysed by cone calorimetry (ISO 5660 Part 1).

### Comparative Examples

Example 3 was repeated replacing the Methoxy-Benzoxazine triethoxysilane and the DOPO siloxane resin T^{DOPO}₃₀T^{Ph}₅₀T^{Me}₂₀ by:

C6—5 wt % phosphate ester (a flame retardant benchmark)

C7—reference sample with no additive (neat polycarbonate)

C8—0.5 wt % potassium diphenylsulfone sulfonate (KSS)

These samples were subjected to the UL-94 Vertical Burn test, as well, and presented longer flaming times (average t1 of 7.5 seconds for C6 and 11 seconds for C7) and dripping with ignition of the cotton placed below the sample and, therefore, a UL-94 V2 rating.

These samples were also analysed by Cone calorimetry and compared with sample of Example 3. This latter sample (sample of Example 3) presented longer time to ignition, lower total heat released and a high fire performance index, which means less fire hazard. Ignition might have been delayed by the condensed phase formed (which was found to be increased for sample of Example 3). The flame out time was found to be the shortest for this sample, which, associated to the longest ignition time, reveals a shorter fire event. More findings on the flame retardancy performance of these samples can be achieved by dividing the fire event in an initial, non-flaming, phase and in a flaming phase. In an initial non-flaming phase, sample of Example 3 exhibited a lower heat release rate, a much lower effective heat of combustion (which is in line with the low HRR and corresponds to a more stable compound), a much lower specific extinction area (meaning lower amount of smoke emitted) and a lower CO₂ emission. These features would translate into a larger time to untenability, i.e., larger time for occupants in structures to escape from fire.

| | C7 | C6 | Example 3 |
|---|---|---|---|
| Time to ignition, tᵢ (s) | 65 | 101 | 106 |
| Total heat released (MJm⁻²) | 109.3 | 104.6 | 97.0 |
| Fire performance index* (m²skW⁻¹) | 0.15 | 0.28 | 0.25 |

*fire performance index = ti/pHRR; the higher, the better

These samples were also analysed by Differential Scanning calorimetry (DSC), which revealed a lower decrease of Tg for sample of Example 3, compared to C7, than C6. i.e., sample of Example 3, sample of Comparative Example C6 and sample of Comparative Example C7 presented a Tg value of 145° C., 151.5° C. and 135° C., respectively.

It can be seen that the blend of 0.5 wt % Methoxy-Benzoxazine triethoxysilane and 2.5 wt % T^{DOPO}₃₀T^{Ph}₅₀T^{Me}₂₀ of Example 3 gave a flame retardance performance which was significantly better than for the comparative example C6 with a FR benchmark at higher loading (5 wt % versus 3 wt %), or C7 (neat polycarbonate). We believe that this shows the synergy of using a nitrogen-containing alkoxysilane and a phosphorus-containing siloxane resin together in a polymer composition.

By cone calorimetry it was possible to determine the MAHRE value, which is closely related to the heat release rate value, of samples of Example 3, Example 4, C7 and C8.

The table below exhibits the different properties assessed for C7 and sample of Example 4. Also, the amount of Si, P, N and phenyl groups (Ph) were calculated in order to correlate this with the MAHRE value and Tg.

The value of MAHRE achieved for sample of Example 4 was found to decrease by 32%, when compared to neat PC(C7).

| | | | wt % | | | |
|---|---|---|---|---|---|---|
| Sample | Tg | MAHRE | Si | N | P | Ph |
| C7 | 151.5 | 240.6 | — | — | — | — |
| Example 4 | 150.3 | 163.5 | 0.408 | 0.019 | 0.123 | 1.223 |

The siloxane formation promotes cross-linking, which is beneficial to the flame extinguishing behaviour. The simultaneous presence of P and N species (P—N synergy) was found to play a major role in the MAHRE value decrease.

We observed, in sample C8, that the addition of KSS at 0.5 wt % (typical amount for maintaining the transparency of the polycarbonate sample) did not decreased the MAHRE and Heat Release Rate values, on the contrary they were further increased compared to neat PC, as seen in the Table below. KSS is typically used, together with PTFE, for inhibiting dripping and therefore achieving a UL-94 V0 classification. However, in terms of Heat Release Rate or MAHRE decrease, it is not working by itself. On the other hand, sample of Example 3 was found to lead to a decrease of the 3 parameters here evaluated, being such decrease even further intense when the Si/P/N is used together with KSS (Example 4). There is, therefore, a synergy when KSS and Methoxy-Benzoxazine triethoxysilane+ and T^{DOPO}₃₀T^{Ph}₅₀T^{Me}₂₀ siloxane resin are employed as FR additives in PC matrix.

| | Peak of heat | | Heat release |
|---|---|---|---|
| Sample | release rate | MAHRE | rate |
| C7 | 444.1 | 240.6 | 228.4 |
| C8 | 399.9 | 248.7 | 270.7 |
| Example 3 | 338 | 204.7 | 208.4 |
| Example 4 | 256.4 | 163.5 | 190.2 |

MARHE(t), the Average Rate of Heat Emission at time t, is defined as the cumulative heat emission per unit area of exposed specimen, from t = 0 to t = t, divided by t. MAHRE is the maximum value of MARHE during that time period.

### Preparation Examples

### F—Synthesis of DOPO-aryl amino silane

### Example 5

### Preparation of PC+3 wt % DOPO-aryl amino silane

9.30 g of the DOPO-aryl amino silane prepared in Preparation Example F were added to 312 g of polycarbonate in an internal mixer compounder at 270° C. The residence time in the mixer was 8 minutes. The matter obtained was pressed in a hot press machine at 250° C. and 100 MPa.

The composition of Example 5 was subjected to the UL-94 Vertical Burn test in which a flame is applied to the free end of a 120 mm×12 mm sample. The sample was self-extinguishing with a flaming time (average t1) of 2 seconds and did not exhibit dripping (UL-94 V0 rating at 1.5 mm). On the other hand, sample C7 (reference sample, neat polycarbonate) exhibited dripping with ignition of the cotton placed below the sample and an average flaming time t1 of 11 seconds, and therefore a UL-94 V2 classification.

1. A process for improving the fire resistance of a thermoplastic, thermoset or rubber organic polymer composition, wherein an alkoxysilane containing at least one organic nitrogen-containing group and an alkoxysilane or silicone resin containing at least one group selected from phosphonate and phosphinate groups are added to a thermoplastic, thermosetting or rubber organic polymer composition and heated in the presence of moisture to cause hydrolysis and siloxane condensation of the alkoxysilane or alkoxysilanes.

2. A process for improving the fire resistance of a thermoplastic, thermoset or rubber organic polymer composition, wherein an alkoxysilane containing at least one group selected from phosphonate and phosphinate groups and a silicone resin containing at least one organic nitrogen-containing group are added to a thermoplastic, thermosetting or rubber organic polymer composition and heated in the presence of moisture to cause hydrolysis and siloxane condensation of the alkoxysilane or an alkoxysilane containing at least one group selected from phosphonate and phosphinate groups and at least one organic nitrogen-containing group is added to a thermoplastic, thermosetting or rubber organic polymer composition and heated in the presence of moisture to cause hydrolysis and siloxane condensation of the alkoxysilane.

3-4. (canceled)

5. A polymer composition comprising a thermoplastic, thermosetting or rubber organic polymer, (1) an alkoxysilane containing at least one organic nitrogen-containing group and an alkoxysilane or silicone resin containing at least one group selected from phosphonate and phosphinate groups or (2) an alkoxysilane containing at least one group selected from phosphonate and phosphinate groups and a silicone resin containing at least one organic nitrogen-containing group or (3) and an alkoxysilane containing at least one group selected from phosphonate and phosphinate groups and at least one organic nitrogen-containing group.

6. The polymer composition according to claim 5 wherein the alkoxysilane containing at least one organic nitrogen-containing group is a trialkoxysilane of the formula RNSi(OR′)3 where RN is an alkyl, cycloalkyl, alkenyl, alkynyl or aryl group having 1 to 20 carbon atoms containing an organic nitrogen substituent and each R′ is an alkyl group having 1 to 4 carbon atoms.

7. The polymer composition according to claim 5, wherein the alkoxysilane containing at least one organic nitrogen-containing group has the formula 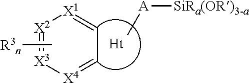
where X¹, X², X³ and X⁴ independently represent a CH group or a N atom and form a benzene, pyridine, pyridazine, pyrazine, pyrimidine or triazine aromatic ring, Ht represents a heterocyclic ring fused to the aromatic ring and comprising 2 to 8 carbon atoms, 1 to 4 nitrogen atoms and optionally 1 or 2 oxygen and/or sulphur atoms; A represents a divalent organic linkage having 1 to 20 carbon atoms bonded to a nitrogen atom of the heterocyclic ring; each R represents an alkyl, cycloalkyl, alkenyl, alkynyl, aryl, aminoalkyl or aminoaryl group having 1 to 20 carbon atoms; each R′ represents an alkyl group having 1 to 4 carbon atoms; a is 0, 1 or 2; the heterocyclic ring can optionally have one or more substituent groups selected from alkyl, substituted alkyl, cycloalkyl, alkenyl, alkynyl, aryl and substituted aryl groups having 1 to 12 carbon atoms and amino, nitrile, amido and imido groups; and R³ₙ, with n=0-4, represents an alkyl, substituted alkyl, alkenyl group having 1 to 8 carbon atoms or cycloalkyl, alkynyl, aryl or substituted aryl group having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms, substituted on one or more positions of the aromatic ring, or two groups R³ can be joined to form a ring system comprising at least one carbocyclic or heterocyclic ring fused to the aromatic ring.

8. The polymer composition according to claim 7, wherein the alkoxysilane containing at least one organic nitrogen-containing group has the formula 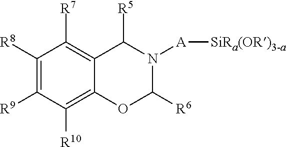
where R⁵ and R⁶ each represent hydrogen, an alkyl, substituted alkyl, cycloalkyl, alkenyl, alkynyl, aryl or substituted aryl group having 1 to 12 carbon atoms, or an amino or nitrile group; and R⁷, R⁸, R⁹ and R¹⁰ each represent hydrogen, alkyl, substituted alkyl, alkenyl group having 1 to 8 carbon atoms or cycloalkyl, alkynyl, aryl or substituted aryl groups having 1 to 40 carbon atoms, or an amino, nitrile, amido or imido group or a carboxylate —C(═O)—O—R⁴, oxycarbonyl —O—(C═O)—R⁴, carbonyl —C(═O)—R⁴, or an oxy —O—R⁴ substituted group with R⁴ representing hydrogen or an alkyl, cycloalkyl, alkenyl, alkynyl, aryl, or substituted aryl groups having 1 to 40 carbon atoms; or R⁷ and R⁸, R⁸ and R⁹ or R⁹ and R¹⁰ can each be joined to form a ring system comprising at least one carbocyclic or heterocyclic ring fused to the benzene ring.

9. The polymer composition according to claim 7, wherein the alkoxysilane containing at least one organic nitrogen-containing group is a bissilane containing two heterocyclic rings each having an alkoxysilane substituent.

10. (canceled)

11. The polymer composition according to claim 8, wherein the alkoxysilane is a bissilane in which the groups R⁷ and R⁸, R⁸ and R⁹ or R⁹ and R¹⁰ form a naphthoquinoid structure and a second heterocyclic ring Ht is attached either to the aromatic ring Ar or to the second aromatic ring of the naphthoquinoid structure.

12-13. (canceled)

14. The polymer composition according to claim 5, wherein the alkoxysilane containing at least one group selected from phosphonate and phosphinate groups is a trialkoxysilane of the formula RPSi(OR′)3 where RP is an alkyl, cycloalkyl, alkenyl, alkynyl or aryl group having 1 to 20 carbon atoms containing a phosphonate or phosphinate substituent and each R′ is an alkyl group having 1 to 4 carbon atoms.

15. The polymer composition according to claim 14, wherein the group RP has the formula 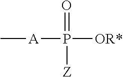
where A is a divalent hydrocarbon group having 1 to 20 carbon atoms, R* is an alkyl or aryl group having 1 to 12 carbon atoms, and Z is a group of the formula —OR* or an alkyl, cycloalkyl, alkenyl, alkynyl or aryl group having 1 to 20 carbon atoms.

16. The polymer composition according to claim 14, wherein the group RP has the formula 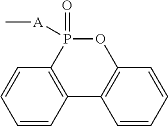
where A² is a divalent hydrocarbon group having 1 to 20 carbon atoms.

17. (canceled)

18. The polymer composition according to claim 5, wherein the phosphonate or phosphinate group and the organic nitrogen-containing group are both present in a group of the form 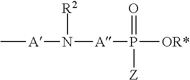
where A′ is a divalent organic group having 1 to 20 carbon atoms, A″ is a divalent organic group having 1 to 20 carbon atoms, R* is an alkyl group having 1 to 12 carbon atoms and Z is a group of the formula —OR* or an alkyl, cycloalkyl, alkenyl, alkynyl or aryl group having 1 to 12 carbon atoms, or R* and Z can be joined to form a heterocylic ring, and R² is hydrogen or an alkyl, cycloalkyl, alkenyl, alkynyl or aryl group having 1 to 12 carbon atoms, or can be joined to A″ to form a heterocyclic ring.

19. The polymer composition according to claim 5, wherein the composition also contains a tetraalkoxysilane of the formula Si(OR′)4 and/or a trialkoxysilane of the formula R4Si(OR′)3, where each R′ is an alkyl group having 1 to 4 carbon atoms and R4 is an alkyl, cycloalkyl, alkenyl, alkynyl or aryl group having 1 to 20 carbon atoms.

20. The polymer composition according to claim 5, wherein the thermoplastic organic polymer comprises a polycarbonate or a blend of polycarbonate with another organic polymer.

21. The polymer composition according to claim 5 wherein the composition contains a filler.

22. The polymer composition according to claim 21, wherein the filler is treated with the alkoxysilane and/or a silicon resin.

23. The polymer composition according to claim 5 wherein the composition contains a silica filler.

24. The polymer composition according to claim 5 wherein the composition also comprises a polydiorganosiloxane gum.

25. The polymer composition according to claim 23 wherein the silica is coated with a polydiorganosiloxane gum.

26. The polymer composition according to claim 5 wherein the composition contains another flame retardant additive.
